(19) United States
(12) Patent Application Publication
(10) Pub. No.: US 2001/0037379 A1
(43) Pub. Date: Nov. 1, 2001

(54) System and method for secure storage of information and grant of controlled access to same

(76) Inventor: Noam Livnat, Menlo Park, CA (US)

Correspondence Address: Noam Livnat, 320 Waverley St., #1, Menlo Park, CA, 94025, US

(21) Appl. No.: 09/818,130

(22) Filed: Mar. 27, 2001

Related U.S. Application Data
(60) Provisional application No. 60/193,753, filed on Mar. 31, 2000.

(51) Int. Cl. G06F 15/16; G06F 15/173

(52) U.S. Cl. 709/219; 709/225

(57) ABSTRACT

A computer system securely stores content items and provides a controlled grant of access to clients attempting to access such content items via a network. The system may include a Web server coupled to a content management system having one or more databases. The databases include the content items, which may take any of a variety of digital forms. For example, the content items may be text, image, audio, video, code, applets, or object files, or some combination thereof. Access to said content items is not directly available to the Web server or the clients. Rather, the content management system operates as an application server to the Web server. The Web server services requests for content items from the clients and, in turn, requests such content items from the content management system. In response, the content management system selectively provides such information (or representation thereof) as a function of satisfaction of certain criteria. As a result, the content information is provided to the clients via the Web server, wherein the content items is transient in the Web server.

This application claims the benefit of Provisional Application No. 60/193,753, filed Mar. 31, 2000.

### FIELD OF THE INVENTION

The present invention generally relates to systems and methods for data storage and access over a network. More specifically, the present invention relates to systems and methods for securely storing such data and selectively controlling access to said data.

### BACKGROUND OF THE INVENTION

To an ever increasing degree, computers and other electronic devices are networked together to provide individuals and organizations with increased access to information and services Many organizations, including corporations, educational institutions, and government agencies now have networks of computers that provide their user's access to the organization's intranet and/or to the Internet and World Wide Web (the “Web”). At the same time, many of these same organizations allow remote access to their intranets via the Internet and Web. For example, an organization may establish a Web presence for public or private use, or some combination thereof

As the growth of information and services available on the Web continues, so too do the means by which the Web and intranets may be accessed. Accordingly, there is a steady migration of Web functionality to an increasing range of wired and wireless computers and electronic devices, such as Web enabled televisions, cell phones, pagers, personal digital assistants (PDAs) and so forth. Each of these devices may be configured to send and/or receive information made available by an organization via the Internet and Web.

In such a case, an organization will typically have one or more Web servers linked to several databases. For a secure site, a user is usually required to login to the Web server to gain access to applications and data resident on or linked to the Web server, or indirectly accessible via the Web server. However, where the applications and data are intended for wide-scale anonymous consumption, which is the large majority of Web sites, a user login is not required. In either case, the user accesses the Web server over the Internet through a standard Web browser, logs in (if required), and accesses the desired and available applications and data. In a customary configuration, data is loaded into the databases and becomes immediately available to its intended group of users.

While many such examples exist, one example of this common system of networked computers, servers, and databases is found in an academic setting. In such a setting, it is increasingly common for a university or college to make course information available via the Web. While some of this information is targeted for general consumption, like course offerings and descriptions, other types of information may be primarily targeted to those individuals having a direct relationship with a particular course (e.g., students registered for the course). For example, a professor may post a syllabus, class notes, homework assignments, and answers to past homework assignments on the network. That is, the professor may load, or have loaded, this information into a database via a server. In such a case, the server may be an intranet server or a Web server and access to the information may be, to one extent or another, restricted to the professor and registered students of the course. Obviously, a professor would not usually want to make answers to current or future homework assignments available to the students until after the students had turned in their own answers. Therefore, homework answers would be incrementally loaded into the databases as the semester progressed, requiring new interaction between the professor (or another individual charged with making such updates) and the system each time homework answers are loaded into the databases.

As an alternative to the incremental loading of data into the databases, the professor may load all of the homework answers into the databases at the beginning of the semester, and incrementally provide access privileges to the students for homework answers after the students answers were due to be turned in. However, even in this approach, the professor (or some other individual) would have to incrementally interact with the system to change the student's access privileges. Either approach can be relatively unsecure and prone to computer “hacking”, since access to the Web server may allow a user to alter privileges or masquerade as a system administrator and thereby fool the server and gain access to the stored answers for current and future homework assignments.

### SUMMARY OF THE INVENTION

The present invention is a system and method that accomplishes the secure storage and controlled grant of access to content items or information sought by clients (i.e., users) attempting to access such content items via a network. The system includes a Web server coupled to a content management system, wherein the content management system is coupled to one or more content databases. The content databases include the content items, which may take any of a variety of digital forms. For example, the content items may be text, image, audio, video, code, applets, or object files, or some combination thereof. Access to the content items is not directly available to the Web server or the users. Rather, the content management system operates as an application server to the Web server. The Web server services requests for content items from users and, in turn, requests such content items from the content management system. In response, the content management system selectively provides such content items (or representations thereof) as a function of satisfaction of certain associated criteria. That is, access to the content items is provided to said clients via said Web server, wherein the content item is only transient in said Web server. The content item may be created and the associated criteria defined within the system by, for example, a computer coupled to the content management system or to the Web server or outside of the system and then transferred to the content databases.

The system may be accessed by any of a plurality of types computers configured to communicate over any of a variety of types of networks, including the Internet and World Wide Web (the “Web”), an intranet, an extranet, local area network (LAN), a wide area network (WAN), a private network or some combination thereof. The term “computers” may be construed broadly to include wired or wireless personal computers, workstations, terminals and electronic devices, such as, telephones, personal digital assistants (PDAs), electronic organizers, electronic pagers, Web enabled televisions, and other network enabled devices.

The Web server and content management system may be physically co-located or remote to each other. If physically co-located, the Web server and content management system may be integrated into the same computer platform, so long as they are logically distinct entities. In some implementations, the system may include a plurality of Web servers, content management systems and content databases, which may be physically co-located or remote to each other, wherein tasks and data may be distributed among the various Web servers, content management systems and content databases. Access to the Web server and communications across the network or portions thereof, may be secure or unsecured, depending on the application of the present invention.

The system includes a variety of functionality, which may be implemented in software, firmware, hardware or some combination thereof. This functionality is made available to a user through a user interface, such as a graphical user interface rendered on the user's computer or a keypad on a telephone, as examples. Preferably, the graphical user interface is rendered within the context of a Web browser, although this is not essential. Through the user's interaction with the user interface, using any of a variety of typical input devices (e.g., keyboard, keypad, mouse, microphone, touch screen, and so on), the user makes requests for content items.

Initially, the user accesses the Web server and may be required to login to the Web server. While a login to the Web server may be preferred, it is not essential to the present invention. The user may also be required to authenticate with the content management system to request access to content items, depending on the configuration of the content management system. Once Web server login and content management system authentication (if required) are accomplished, the user is given an opportunity to request content items. The content management system and associated content database maintain a content listing and content items (e.g., files, data elements, objects, and data entries) in the content databases. The user is presented with one or more mechanisms from which he may request content information (e.g., a content list, a content search interface, a hyperlink or a URL field). The Web server accepts the user's request for a content item and presents a corresponding request to the content management system. The Web server may include an application program interface (API) which duly prepares the request for the content management system. Where access to the content item is to be limited to a select group of users, the request includes some indication of the identification of the user that originated the request along with an indication of the content item requested by that user. If the grant of access to the content item is also contingent upon a user's history or profile information (e.g., stored in a content database), such information is analyzed before access is granted.

The content management system may be comprised of a server hosting a content management system program, wherein the server is linked to the content databases. In such a case, the content management system program may include several functional managers that work together to control access to the content items stored in the content databases. For example, the content management system program may include a system manager that provides the basic administration of the content management system, including generating and assigning tasks associated with a request for content, generating system alerts, and managing the interface and exchange of messages with the Web server. An authentication manager may also be included in the content management system that ensures, via a username and password, for example, that the user has authority or rights to access the system.

A content manager may also be included in the content management system program and is generally responsible for the storing and reading of content information to and from the content databases. A criteria manager may also be included that maintains a set of criteria associated with the content information. To accomplish its tasks, the criteria manager is responsive to the system manager, wherein each user's request for content information is forward by the system manager to the criteria manager. The criteria manager compares the information included in the request (e.g., user identification and content identification) to corresponding stored information and may apply additional criteria to the user's request to determine whether access to the requested content information is to be granted. The additional criteria may be defined by the creator of the content information or by an entrusted administrator or individual, or could be defined as a function of preprogrammed logic included with the system, such as to track, store and apply user history and profile information. The criteria may be used to provide different levels of access to content items (e.g., refusing access, read only access or write and read access) or different durations of access to content items (e.g., for two hours from the grant of access), and/or different periods of access to the content items by different users (e.g., release on Jan. 10, 2000 for Group I users, release on January 17th for Group 2 users). In such cases users may be classified or grouped and the criteria may be class or group based. If the criteria are not satisfied, the criteria manager provides an indication to the system manager and the system manager sends a message to the Web server that the request has been denied, which is passed on to the user's computer. Preferably, some indication as to why access was denied is also provided (e.g., the user is not registered as a member of a certain group for whom access is available). As an alternative or in conjunction with such an indication, other events may be triggered, such as alerts to system administrators that a user may be attempting to “hack” the system.

As an example, in an academic setting a professor (i.e., content creator) may load an automated midterm exam and final exam (i.e., content items) for his Spring 2000 Semester class in the content databases via the content management system. The professor may define that only students registered for his Spring 2000 Semester class and his teaching assistant (TA) may access the midterm and final exams and that the student's access to the midterm exam must be read-only and for a period between Mar. 14, 2000 and Mar. 15, 2000, and that the duration of access shall be for a period not to exceed 3 hours (the time allowed for taking the examination). Furthermore, each student may be limited to one access of each exam. On the other hand, the teaching assistant may be given read and write privileges to the midterm exam, but read-only privileges to the final examination, and his access may be for the start and end dates of the semester, for unlimited duration, and for multiple accesses.

As will be appreciate by those skilled in the art, the present invention for controlling and granting access to content items may be implemented in a variety of different contexts and applications. Certainly, in any system where access to information is time dependent the present invention may be employed. For example, in an e-commerce Web site a retailer may enter all promotional events at the start of the year and selectively give access to information related to those promotional events according to a timed-release schedule. Additionally, the retailer may give different (i.e., more favorable) access to “preferred” customers. Although, the particular criteria by which access is granted or refused need not be time related. For example, access may be related to other events, such as completion of preceding events in a series of events.

### BRIEF DESCRIPTION OF THE DRAWINGS

The foregoing and other objects of this invention, the various features thereof, as well as the invention itself, may be more fully understood from the following description, when read together with the accompanying drawings, described:

FIG. 1 is schematic diagram of a system for the secure storage of information and grant of controlled access to the stored information, in accordance with the present invention;

FIG. 2 is a functional block diagram depicting the preferred functional modules included in the system of FIG. 1;

FIGS. 3A through 3E are illustrative tables, representing objects, used by the system of FIG. 1 for managing access to information; and

FIG. 4 is a flowchart depicting a method of securely storing and granting controlled access to information using the system of FIG. 1.

For the most part, and as will be apparent when referring to the figures, when an item is used unchanged in more than one figure, it is identified by the same alphanumeric reference indicator in all figures.

### DETAILED DESCRIPTION OF THE PREFERRED EMBODIMENT

The present invention is an access controlled system and method that accomplishes the secure storage of and controlled grant of access to content information sought by clients (i.e., users) attempting to access such content information via a network. In the preferred embodiment, the present invention is applied in an academic setting for illustrative purposes. However, as will be appreciated by those skilled in the art, the present invention has wide-scale application and is not restricted to academic settings. In the illustrative academic setting, a university selectively and dynamically provides access to course related information over a network. Users, which may include faculty, administrators, and students, access the course related information via the network using any one of a variety of devices. Access to the information is provided as a function of a set of parameters and a set of predetermined criteria being satisfied, wherein such access is preferably time and user constrained. The criteria and the corresponding constraints will vary, depending on the application of the present invention.

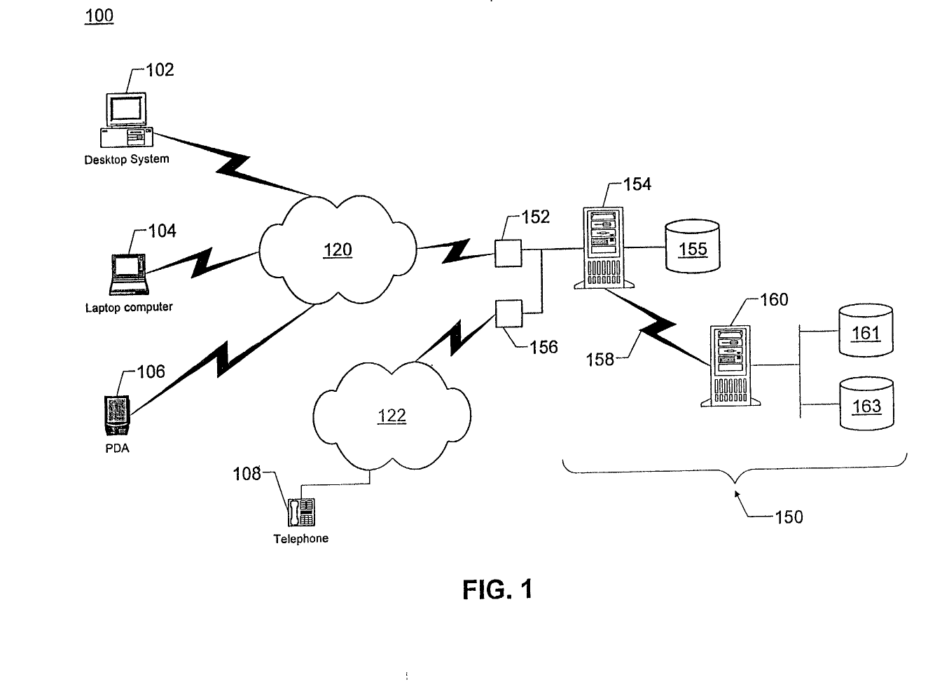

One architecture 100 that may include the present invention is shown in FIG. 1, wherein the preferred embodiment of an access controlled system is collectively referred to as reference numeral 150. The access controlled system 150 may be part of a local area network (LAN), wide area network (WAN), and/or intranet, with various known types of network security measures and devices optionally included (e.g., data encryption). Preferably, the access controlled system 150 is also accessible via the Internet and Web, as indicated generally by network cloud 120, or by a telephone 108 via a telephone network, as indicated by communications cloud 122. The access controlled system 150 includes a content management system 160 having an access controller 162 and at least one content database 163 and may also include a system database 161. The content database 163 includes the content information sought by user's of the access controlled system 150 and the system database 161 includes other data and programs used more generally by the content management system 160. In other embodiments, the data from each database may be combined or distributed among several databases. The content management system 160 access controller 162 may take the form of any known server architecture running a standard network operating system (NOS), to support operations over the network. Additionally, content management system 160 supports communications using standard protocols.

In the preferred form, the access controlled system 150 also includes a standard Web server 154 coupled to content management system 160, as depicted by link 158. Link 158 may take any known form, and need not be a physical link between Web server 154 and content management system 160. Web server 154 acts as an interface between remote, Web-enabled devices and content management system 160 access controller 162, and also supports standard protocols, such as TCP/IP. Web server 154 may or may not act as a passive gateway to content management system 160. Regardless, content management system 160 access controller 162 is configured to be an application server that is accessed by Web server 154 in response to the receipt by the Web server of a request from a user for content items.

As a measure of security, a user may be required to login to Web server 154 and/or access controller 162 prior to the Web server sending a request for a content item to the content management system 160. If login to the Web server is required, a database 155 associated with Web server 154 includes registration and login information (e.g., usernames and passwords), along with other typical data and code necessary for its operation. If an authentication of the user is required with the content management system 160, user authentication information (e.g., username and password) may be stored in system database 161. In any event, access to Web server 154 does not result in automatic access to the content information in content database 163, in the preferred embodiment. Instead, access to Web server 154 allows a request for a content item to be submitted to content management system 160. Whether or not that request is granted is determined by the content management system 160.

The content management system 160 may be accessed by any of a variety of commercially available computers and electronic devices over the Internet and Web 120 and via a standard network interface device 152 (e.g., a network interface card or a modem) and Web server 154. For example, a user may access Web server 154 via the Internet and Web with any Web-enabled computer or electronic device, such as a desktop personal computer 102, a laptop computer 104, or a Web-enabled PDA 106. The number and type of Web-enabled computers and electronic devices is ever increasing and the particular items 102, 104, and 106 shown in FIG. 1 are meant to be representative of such computers and electronic devices and are not meant to be an exhaustive representation thereof. In the illustrative embodiment, a user has a personal computer running a standard Wed browser (e.g., Internet Explorer™ by Microsoft Corporation of Redmond, Wash.) and accesses a university Web server (i.e., Web server 154) via the Internet and Web 120. Other Web-enabled devices will include corresponding programs that facilitate interaction with standard interfaces used in the access controlled system 150, as will be appreciated by those skilled in the art. As an example, particular Web-enabled models of the Palm Pilot™ (by Palm, Inc. of Santa Clara, Calif.) include software for facilitating interactions with other systems on the Internet and Web. Therefore, preferably the access controlled system 150 need only support standard interfaces and protocols.

In addition to supporting communications via the Internet and Web, the access controlled system 150 also supports communications and requests made via standard telephone devices over existing telephone networks, represented by telephone 108, communications cloud 122 and network interface device 156. In such a case, rather than interacting with the access controlled system 150 via a Web browser graphical user interface, the telephone user may interact with the system via the telephone keypad or receiver, if the access controlled system 150 includes a voice recognition program and/or voice activation program. As an example, a student may input his student identification number, be provided with a corresponding menu of options relating to the courses for which he is registered, select a course, be presented with a list of content items for the selected course, and select a menu option. Based on satisfaction of certain criteria the user may be presented with, for example, this week's homework assignment, last week's homework answers, or his grade on the last exam.

The actual content items stored in content database 163 will, of course, vary depending on the application for which the access controlled system 150 is implemented. The content items may take any of a variety of digital forms. For example, the content items may be text, image, audio, video, code, applets, object files, or some combination thereof. In the preferred embodiment, the content items include course related information. The course related information may take any of a variety of forms, and will typically be largely determined by the professor responsible for the particular course in question. As examples, the course related information (or content items) may include a course syllabus, class notes, homework assignments, homework answers, audiovisual lectures, graphic images, reading materials, automated examinations, and student grades.

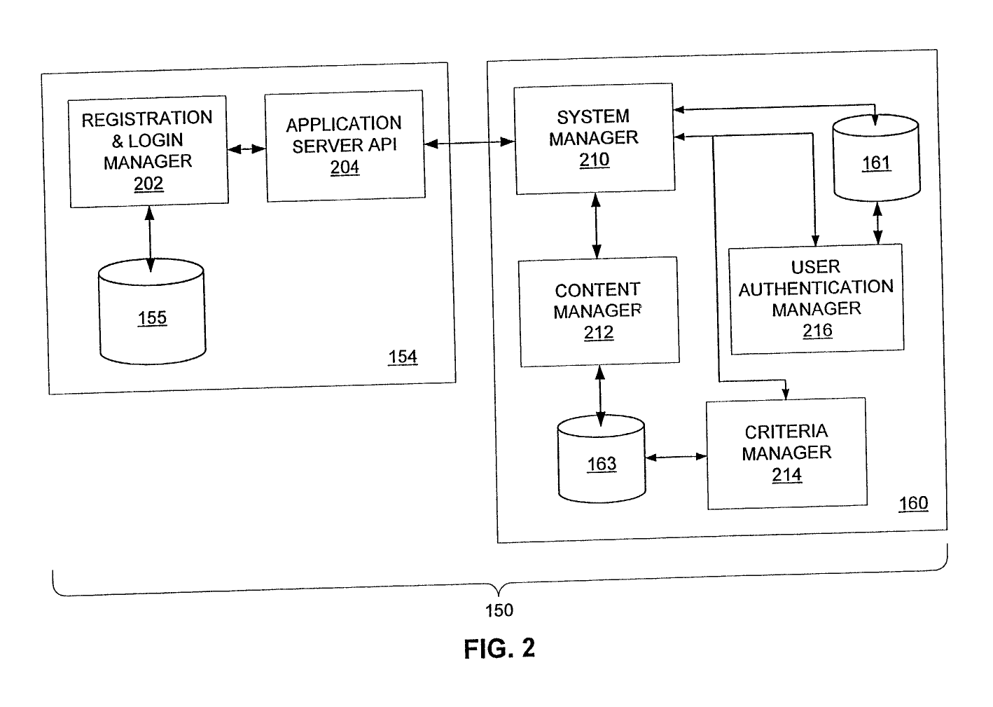

FIG. 2 shows a simplified functional diagram 200 of the access controlled system 150 of FIG. 1. With regard to Web server 154 and content management system 160, for simplicity, standard operating systems and other program codes known in the art are omitted from FIG. 2. Web server 154 and content management system 160 may be physically co-located in the same platform, so long as they are logically distinct. In the preferred embodiment, the Web server 154 includes an application server application program interface (API) 204 and may include a registration & login manager 202. That is, where the access controller 162 is acting as an application server to Web server 154, the application server API 204 facilitates proper communications in terms of protocols, message formats, and so on between the two devices. As an example, content management system 154 may be created as a ColdFusion™ cross-platform application server; wherein application server API 204 is a ColdFusion™ API. ColdFusion™ is provided by Allaire Corporation of Cambridge, Mass. As such, content management system 160 includes such features as Java™ integration, XML parsing, service level failover, server clustering, open integration and scalability, among other ColdFusion™ related features.

When included, the registration & login manager 202 services each user's login request to the access controlled system 150. The user attempts to login by entering a username and password at his computer and the registration & login manager 202 compares the user's information against its database of registered users, stored in database 155, to determine if a username and password match exists. If not, the user is denied access, but if a match does exist the user is allowed to request content information. Registration and login systems vary in their complexity and robustness, and one of a variety of such registration and login systems may be included in the access controlled system 150. In other embodiments, registration and login may not be required, or may be required to gain access to some content information, but not to other content information.

Content management system 160 includes a system manager 210, a content manager 212, a criteria manager 214 and may also include a user authentication manager 216. The user authentication manager (if included) serves to authenticate a user requesting access to the content management system 160 and content items, such as by a username and password, for example. The system manager 210 performs the primary administrative functions of content management system 160, including servicing requests from Web server 154 (or application server API 204) and generating tasking to the user authentication manager 216, content manager 212 and criteria manager 214. The content manager 212 accomplishes the reading and writing of content information (or content items) into content database 163 and maintains a table or tables (e.g., files) of content items that are dynamically updated as content items are added or removed from content database 163. Content items may include files, objects, data elements, data entries, or other such entities capable of electronic storage. Alternatively, the table of content items may be established and maintained by criteria manager 214, which also provides a mechanism for the establishment and maintenance of a set of criteria associated with each content item stored in content database 163. The criteria manager, preferably, also facilitates the establishment and maintenance of a file of valid user's of the system. The criteria may be placed in one or more tables, stored in content database 163, and associated with the table of content items provided by the content manager 212.

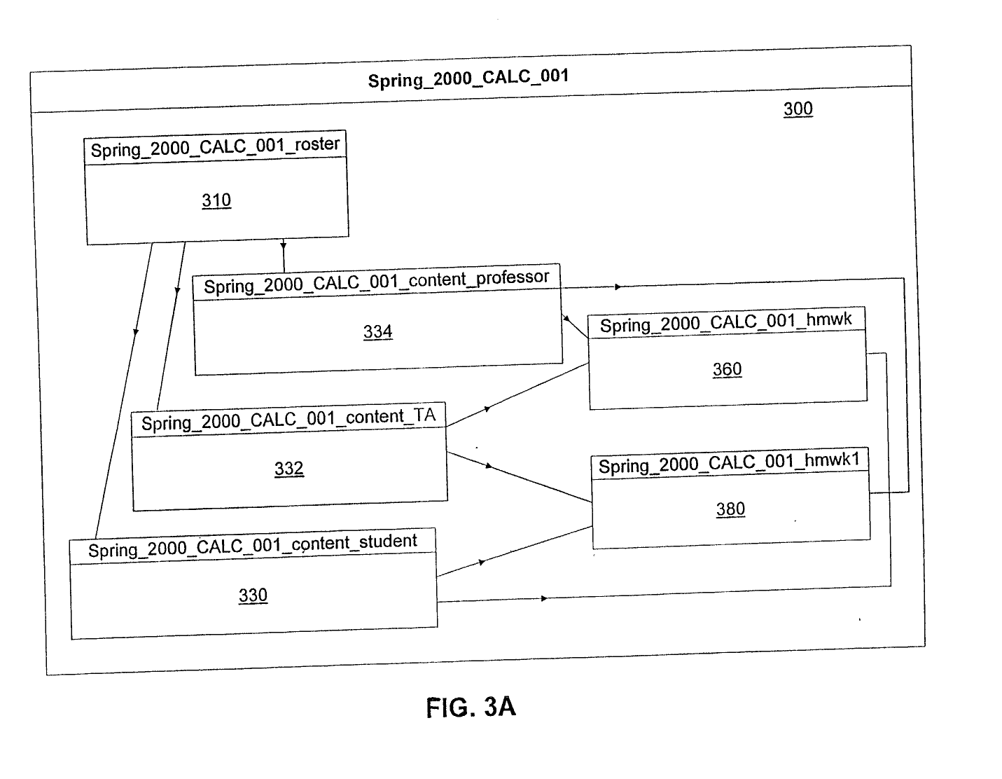

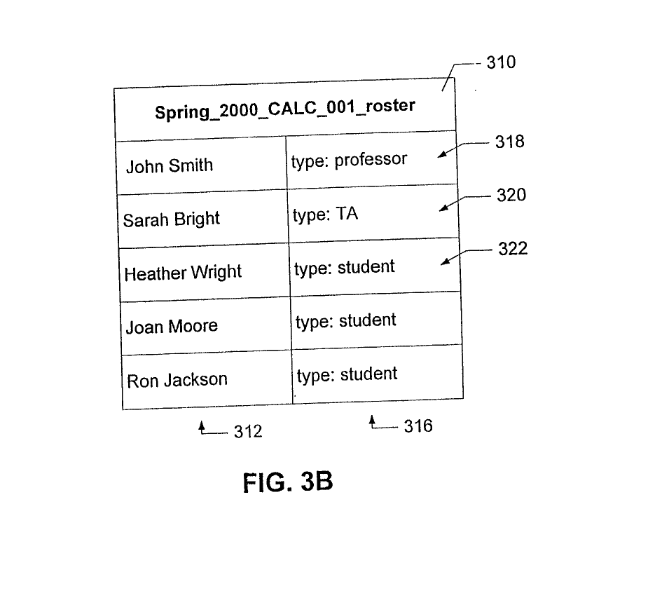

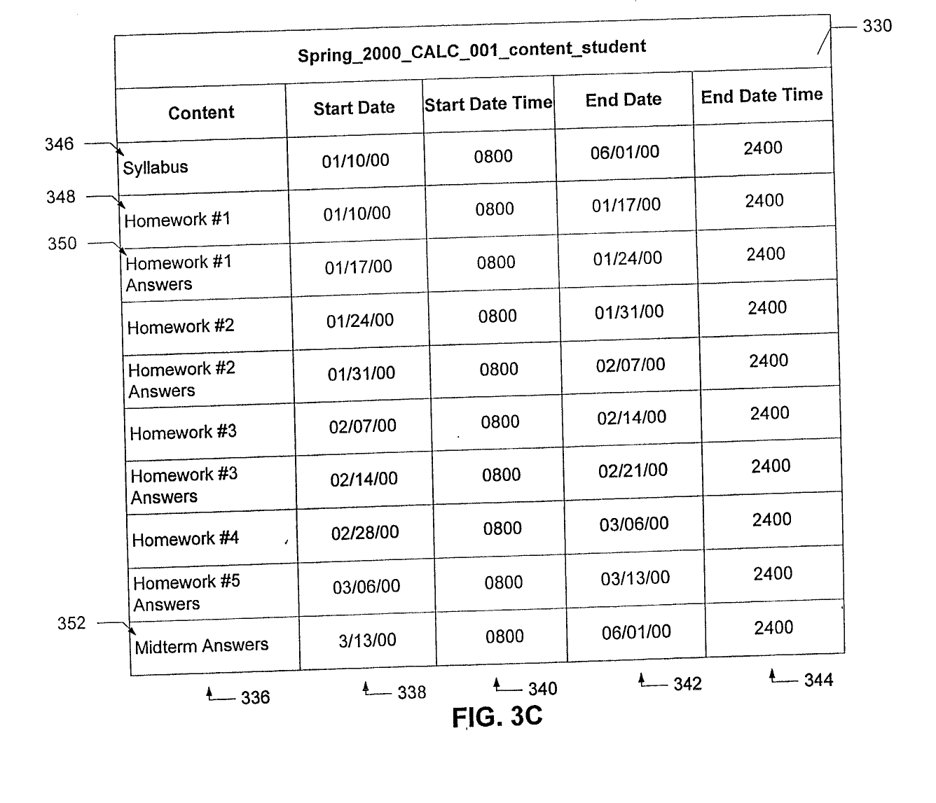

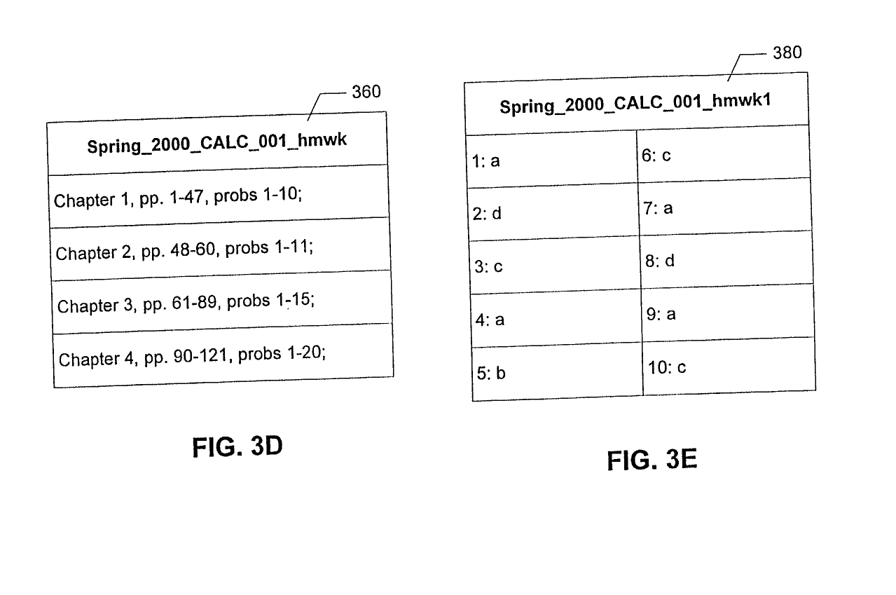

FIGS. 3A through 3E provide an object oriented embodiment of the various elements that may be generated by content manager 212 and criteria manager 214 for a given course. Although, those skilled in the art will appreciate that an object oriented implementation is not required and that, even in an object oriented implementation, the actual objects, data elements and methods may vary, without departing from the present invention. In the illustrative academic setting, a course object 300 that represents a university's Spring 2000 semester Calculus I course is shown in FIG. 3A. A different object may be created for each course offered by the university. Course object 300 may include objects representing or providing an association (e.g., such as the tables referred to above) to each corresponding content item stored in content database 163 for that course. For example, course object 300 may maintain a series of related content tables as objects, such as a course roster object 310, a course content object for students 330, a course content object for teaching assistants (TAs) 332, a course content object for the professor 334, a course homework object 360 and a course homework answers object for each homework assignment (e.g., object 380). In object 300, each type of user represented (i.e., professor, TA, and student) has different rights regarding content items, thus the different content objects 330, 332 and 334. Therefore, a different time window of access can be defined for different types of users for the same content item. Many other types and items of content information may also be included, but have been omitted for simplicity.

As is shown in FIG. 3B, the course roster object 310 (i.e., Spring_{—}2000_CALC_{—}001_roster) of course object 300 includes a list of all individuals associated with the course that may seek to store or access content items in the access controlled system 150. The list includes an identification of each user (e.g., “John Smith”) in column 312, and an indication of the type of user (e.g., “type: professor”) in column 316. In the preferred form the user type serves as a parameter for determining access to content items. In FIG. 3B, the types include professor 318, TA 320, and student 322, but other types of users may also be defined (e.g., system administrator, dean, and so on) and each of these types of users may have different rights of access. For example, the professor may have rights to store content items in content database 163, define the criteria associated with each content item, make subsequent modifications to criteria and content items, and view all course related content items at any time. In contrast, the TA may have access to all course related content items at any time, but on a read-only basis and only for the semester. As such, the user type acts to filter the content database 163, along with the identification of the user and the course.

FIG. 3C shows the student content object 330 of FIG. 3A represented as a table, which shows (a subset of) the course related content items in the content database 163 available to students for this course (i.e., Calculus I). Content objects 330, 332, and 334 also act as filters of the content database 163. The content items are presented in column 336 and include a syllabus 346, a variety of homework assignments (e.g., Homework #1 348), homework answer sets (e.g., Homework #1 Answers 350), and Midterm Answers 352. These content items may be represented as pointers to content item files stored in content database 163.

The table 330 also includes a series of criteria columns, i.e., columns 338, 340, 342, and 344, associated with the content items, wherein satisfaction of the criteria make the content available for access by the applicable type of user, in this case students. In the preferred embodiment, the criteria define a time window of access. Columns 338 and 340 provide access start date and time criteria, respectively, and columns 342 and 344 provide access end date and time criteria, respectively. If the start date and time are in the past when entered and the end date and time are in the future, access to the content item is immediately available. If both start and end dates and times are in the past, access to the content item is never granted.

While in the preferred embodiment the criteria are date and time related, other criteria may be defined to augment, modify, or replace the date and time criteria of the preferred embodiment. For example, duration criteria may be included, wherein once a user accesses a content item, that content item is only accessible to that user for a set period of time thereafter. For example, a content item may be a midterm exam that each student may access over the network for a period of 3 hours starting at the time the student gains access to the midterm file.

Preferably, a professor would input all content items and associated criteria prior to the start of the semester and the content management system 160 would dynamically make content items available for access throughout the semester according to the professor's criteria associated with each content item for each type of user. The professor may load, and possibly create, content items from within the system, i.e., directly accessing content management system 160. As an alternative, the professor may create content items external to the content management system and load the content items into the content management system over the Web via Web server 154.

As an example, assuming the Spring semester begins on Jan. 10, 2000 and ends on Jun. 1, 2000, the syllabus 346 is made accessible to the students on “Jan. 10, 2000” at 8:00 am (i.e., 0800) and remains available until midnight (i.e., 0000 on “Jun. 1, 2000”), as shown in FIG. 3C. However, Homework #1 348 is made available for access from “Jan. 10, 2000” at 8:00 am until “Jan. 17, 2000” at midnight, wherein Homework #1 348 is an entry in the course homework object 360, as is shown in FIG. 3D. Assuming Homework #1 348 is due no later than 8:00 am on Jan. 17, 2000, the corresponding Homework #1 Answers 350 content item (shown in FIG. 3E) becomes available for access on “Jan. 17, 2000” at 8:00 am, i.e., after the homework has been turned in. Similar types of start dates and times and end dates and times are established for the other items of content information, as shown in FIG. 3C.

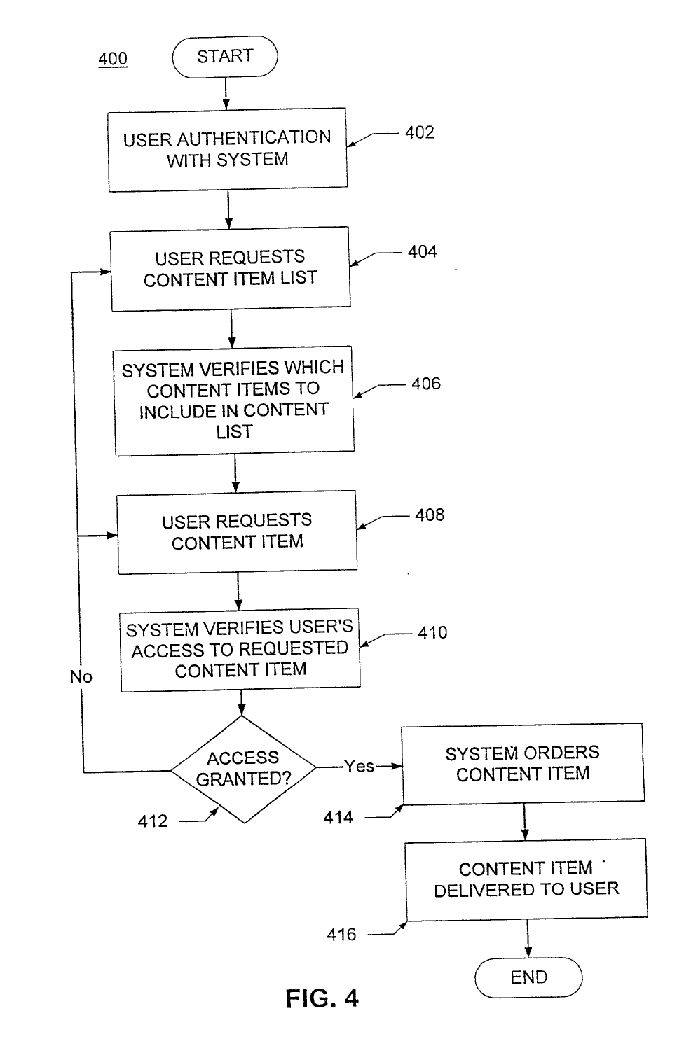

A method 400 for requesting content items from the accessed controlled system 150 is shown in FIG. 4. Steps 402 through 406 are optional, but steps 408 through 416 are generally required, in one form or another. In step 402 a user (e.g., a student) authenticates with the user authentication manager 216 of the content management system 160. In the preferred embodiment, the authentication step involves providing an identification of the user that is recognized by content management system 160. User authentication may require additional information about the user, including his relationships to different groups, as well as his function or position within an organization. A login with Web server 154 (if included) may be required prior to authenticating with the content management system 160. In some embodiments, a user may be allowed to remain anonymous, for example, where content items are made available for access to the general public. Such items may have associated criteria and constraints and a user type corresponding to anonymous users may be defined. In step 404, the user requests a list of content items, wherein the request includes certain parameters, including the identification of the user and of a given course. The request may be accomplished using any manner of known mechanisms, such as manipulating a category (or directory) tree, entering text into a search field, selecting a hyperlink, or entering a URL. A corresponding request is forwarded to system manager 210 and includes the users identification and course identification. System manager 210 tasks criteria manager 214, to determine whether the user is associated with the course. Criteria manager 214 queries the course roster (e.g., table 310) to determine whether the user is associated with the course and generally entitled to access content items related to the identified course.

In step 406, the content management system 160 verifies which content items should be included in a content list that is sent to the user in response to the user's request. The content management system 160 may return a content list generated according to an internal algorithm, e.g., content items that became available in the last two days or content items that will not be available within 2 hours (i.e., are expiring). In the illustrative course example, if the user is not included in the course roster 310, a content list is not returned and presented to the user, but rather a message is provided indicating that the user is not entitled to access information for that course. If the access controlled system accommodates anonymous types of users and the course has content items available to anonymous users, the user will be provided with a list of content items available to such users. Otherwise, if the user (e.g., Heather Wright) is included in roster 310 of FIG. 3B, the user will be presented with a list of content items available for access. Referring to FIGS. 3A and 3B, the roster 310 identifies Heather Wright as a user of type “student”. As a result, the table of content related to students (e.g., table 330) will be queried by criteria manager 214 to generate the content list in response to Heather Wright's request. Therefore, the content items included in the content list will be a function of the user being associated with the course and the type of user making the request. Referring to FIG. 3C, if the date were Jan. 15, 2000 when Heather Wright made a request for a list of content items for the Calculus I course, the content list returned in response to the request would include Syllabus 346 and Homework #1 348. The content list could also contain all other student related content items for the course, shown in part in FIG. 3C, but those content items not available for access by the user when the request was submitted would not be selectable. Also, if there were also content items available to anonymous users, those items would also be included in the returned content list.

In step 408, the user requests a content item, either from the returned content list or from a different mechanism, such as entry in a URL field. If the user had received a content list, the content list may include a user selectable hyperlink for each content item listed, but a text entry box for searching content database 163 may also be included to facilitate a search by a content item identification. A search may be attempted by telephone menu selection or other known mechanisms. Regardless of the mechanism used, a request for access to the selected content item is passed to the content management system 160, which then verifies that the user is entitled to access the requested content item, in step 410. This step is particularly important if the user is not selecting from a content list formed based on the user's identification and available access to content items. If the content management system 160 determines, by reviewing the roster 310 and content list 330, for example, that the user is not entitled to access, in step 412, the requested content item, a message indicating such may be returned to the user and one or more of several events may be triggered. As shown in FIG. 4, the user may be returned to the previous screen to request another content item (step 408) or to request another content list (step 404). As an alternative or in conjunction with these events, system alerts, for example, may be generated and communicated to system administrators or other personnel. Otherwise, if the content management system 160 determines in step 412 that the user is entitled to access the requested content item, the process continues to step 414, wherein the system manager 210 orders the content manager 212 to retrieve the corresponding content item from content database 163. Accordingly, the content item or a representation thereof is delivered to the user in step 416. The content item may or may not be capable of being downloaded, depending on the configuration of the content management system 160. In analogous manners, each type of user is granted controlled access to content items.

The invention may be embodied in other specific forms without departing from the spirit or central characteristics thereof The present embodiments are therefore to be considered in all respects as illustrative and not restrictive, the scope of the invention being indicated by appending claims rather than by the foregoing description, and all changes that come within the meaning and range of equivalency of the claims are therefore intended to be embraced therein.

What is claimed is:

1. A system for secure storage of information and controlled grant of access to said information to clients on a network, said system comprising:
A. a server
B. a client computer coupled to said server via said network;
C. a datastore configured to store said information; and
D. an access controller coupled between said server and said datastore, wherein said access controller is adapted to function as an application server and provide a data representation of said information to said client by way of said server and said network as a function of:
(1) a request from said client sent by way of said network and said server; and
(2) predetermined criteria;
wherein said data representation is transient in said server.

2. A system as in claim 1, wherein said network includes the Internet and World Wide Web.

3. A system as in claim 1, wherein said network includes a telephone network and said system includes a telephone coupled to said access controller via said telephone network.

4. A system as in claim 1, wherein said predetermined criteria define a time window for which said information is available for access.

5. A system as in claim 1, wherein said criteria includes a start date, wherein said start date defines when said information is made available for access.

6. A system as in claim 1, wherein said criteria includes a period of duration of access, wherein said period of duration of access commences upon said information being accessed by said client.

7. A system as in claim 1, wherein said criteria includes an end date, wherein said end date defines when said information ceases to be available for access.

8. A system as in claim 1, wherein said criteria includes a start date and a start time, wherein said start date and start time define when said information is made available for access, and further includes an end date and an end time, wherein said end date and end time define when said information ceases to be available for access.

9. A system as in claim 1, wherein said request from said client includes a client identification and an information identification.

10. A system as in claim 1, wherein said clients are typed and said data representation is provided to said client as a further function of a client type.

11. A system as in claim 10, wherein said predetermined criteria may be different for different client types.

12. A system as in claim 1, wherein said information includes a plurality of content items and said access controller provides to a graphical user interface of said client computer a client selectable content list, indicating content items for which said data representations can be provided to said client, wherein said client may generate said request by selecting a desired content item from said content list.

13. A system as in claim 1, wherein a graphical user interface of a client computer includes mechanisms to facilitate said client generating said request by entering a URL, entering a content item identification, performing a text search, or manipulating a directory tree.

14. A system as in claim 1, wherein said criteria include criteria for verifying that said client is entitled to be granted access to said information, said criteria for verifying including an identification of said user.

15. A system according to claim 1, wherein said data representation is provided as a further function of history and profile information associated with said client.

16. A method for the secure storage and controlled grant of access to information in a datastore, wherein an access controller is coupled between said datastore and a server which is accessible by clients over a network, and wherein said access controller is adapted to function as an application server to said server, the method comprising the steps of:
A. requesting said information by said client;
B. verifying that said client is entitled access to the information, as a function of:
(1) said user's request for said desired information; and
(2) predetermined criteria; and
C. providing a data representation of said information to said client, wherein said data representation is transient in said server.

17. A method as in claim 16 wherein said network includes the Internet and World Wide Web.

18. A method as in claim 16 wherein said network includes a telephone network and a telephone coupled to said access controller via said telephone network.

19. A method as in claim 16, wherein said predetermined criteria define a time window for which said information is available for access.

20. A method as in claim 16, wherein said criteria includes a start date, wherein said start date defines when said information is made available for access.

21. A method as in claim 16, wherein said criteria includes a period of duration of access, wherein said period of duration of access commences upon said information being accessed by said client.

22. A method as in claim 16, wherein said criteria includes an end date, wherein said end date defines when said information ceases to be available for access.

23. A method as in claim 16, wherein said criteria includes a start date and a start time, wherein said start date and start time define when said information is made available for access, and further includes an end date and an end time, wherein said end date and end time define when said information ceases to be available for access.

24. A method as in claim 16, wherein said request for said information includes a client identification and an information identification.

25. A method as in claim 16, wherein said clients are typed and said data representation is provided to said client as a furtherfunction of a client type.

26. A method as in claim 25, wherein said predetermined criteria may be different for different client types.

27. A method as in claim 16, wherein said information includes a plurality of content items and the method includes, prior to step A, a step:
C. providing to a graphical user interface of a client computer a client selectable content list, indicating content items for which said data representations can be provided to said client.

28. A method as in claim 16, wherein a graphical user interface of a client computer includes mechanisms to facilitate said client requesting said information, in step A, by entering a URL, entering a content item identification, performing a text search, or manipulating a directory tree.

29. A method as in claim 16, wherein step B includes verifying an identification of said user.

30. A method as in claim 16, wherein step B includes verifying said client is entitled to said data representation as a function of history and profile information associated with said client.
